(19) United States
(12) Patent Application Publication
(10) Pub. No.: US 2011/0126729 A1
(43) Pub. Date: Jun. 2, 2011

(54) REGISTER APPARATUS OF PRINTING PRESS AND REGISTER METHOD FOR PRINTING PRESS

(75) Inventors: Tomoyuki MORONO, Tsukuba-shi (JP); Tadahiko IINO, Tsukuba-shi (JP); Megumi KIKUCHI, Tsukuba-shi (JP)

(73) Assignee: KOMORI CORPORATION, Tokyo (JP)

(21) Appl. No.: 12/955,589

(22) Filed: Nov. 29, 2010

(30) Foreign Application Priority Data
Nov. 30, 2009 (JP) 2009-271293

(51) Int. Cl. B41F 1/34

(52) U.S. Cl. 101/481; 101/485

(57) ABSTRACT

In a printing press including a printing section to print patterns, a register apparatus captures an image of register marks printed in the printing section, and causes positions of the patterns, which are to be printed in the printing section, to be in register on the basis of positions of the register marks in the image. The register apparatus comprises: a front surface camera or a back surface camera for capturing an image of an edge of a print sheet together with the register marks, the print sheet already subjected to printing in the printing section; and a first-color register adjustment mechanism, a second-color register adjustment mechanism, a third-color register adjustment mechanism and a fourth-color register adjustment mechanism for adjusting the positions of the patterns to be printed in the printing section, on the basis of the positions of the register marks in the image and a position of the edge of the print sheet in the image.

### TECHNICAL FIELD

The present invention relates to a register apparatus of a printing press and a register method for a printing press.

### BACKGROUND ART

Heretofore, in single- and multi-color printing presses, lateral color registration has been performed as disclosed in Patent Literature 1 listed below. Specifically, a camera is moved to a register-mark lateral position by use of a motor and is caused to capture an image of register marks of all the colors. Then, the amounts of misregister between the colors are calculated based on the positions of the register marks in the image.

### CITATION LIST

### Patent Literatures

{Patent Literature 1} Japanese Patent Application Publication No. Sho 61-118249

{Patent Literature 2} Japanese Utility Model Registration Application Publication No. Sho 64-42135

### Non-Patent Literature

{Non-patent Literature 1} Masatoshi Okutomi and 15 others, “Digital Image Processing,” 2nd Edition, Computer Graphic Arts Society, Mar. 1, 2006, p. 114-121, 202-205

### SUMMARY OF INVENTION

### Technical Problems

However, in the case of such conventional lateral color registration in single- and multi-color printing presses, it is impossible to figure out the relative positions of printed patterns with respect to the print sheet, thereby causing a first problem that the patterns may be printed off the center of the print sheet.

In addition, in lateral color registration in multi-color double-sided printing presses, as disclosed in Patent Literature 1 listed above, front-surface and back-surface cameras are moved to register-mark lateral positions by use of motors, respectively, and are caused to capture images of register marks of all the colors on the respective front and back surfaces. Then, the amounts of misregister between the colors are calculated based on the positions of the cameras and the positions of the register marks. Here, the positions of the cameras are aligned by use of mechanisms such as ball screws, and therefore there exists backlash. This makes it difficult to accurately align the positions of the front-surface and back-surface cameras and causes a second problem that detection errors may occur.

Moreover, in registration in sheet-fed printing presses that perform printing on separate paper sheets, the same problems occur in circumferential registration and skewing registration.

To solve such problems, the present invention aims to provide a register apparatus of a printing press and a register method for the printing press, with which registration can be performed correctly and accurately for each color and between the front and back surfaces.

### Solution To Problem

A register apparatus of a printing press according to a first aspect of the invention to solve the aforementioned problems includes a printing section to print a pattern, the register apparatus capturing an image of register marks printed in the printing section, and causing a position of the pattern, which is to be printed in the printing section, to be in register on the basis of position of the register mark in the image, the register apparatus comprising: image-capturing means for capturing an image of an edge of a print sheet together with the register marks, the print sheet already subjected to printing in the printing section; and adjustment means for adjusting the position of the pattern to be printed in the printing section, on the basis of the position of the register mark in the image and a position of the edge of the print sheet in the image.

The register apparatus of the printing press according to a second aspect of the invention to solve the aforementioned problems is the register apparatus of the printing press according to the first aspect of the invention, wherein, the printing press includes a first printing section to print a pattern of a first color and a second printing section to print a pattern of a second color different from the first color, the register apparatus of the printing press captures an image of a first register mark and a second register mark printed respectively in the first and second printing sections, the register apparatus of the printing press causes positions of the patterns, which are to be printed respectively in the first and second printing sections, to be in register on the basis of positions of the first and second register marks in the image, the image-capturing means captures an image of an edge of a print sheet together with the first and second register marks, the print sheet already subjected to printing in the first and second printing sections, and the adjustment means adjusts any one of the position of the pattern to be printed in the first printing section and the position of the pattern to be printed in the second printing section, on the basis of the position of the first register mark in the image, the position of the second register mark in the image, and a position of the edge of the print sheet in the image.

The register apparatus of the printing press according to a third aspect of the invention to solve the aforementioned problems is the register apparatus of the printing press according to the first aspect of the invention, wherein, the printing press includes a first printing section to print a pattern on a front surface of a print sheet and a second printing section to print a pattern on a back surface of the print sheet, the register apparatus of the printing press captures an image of a first register mark and an image of a second register mark printed respectively in the first and second printing sections, the register apparatus of the printing press causes positions of the patterns, which are to be printed respectively in the first and second printing sections, to be in register on the basis of positions of the first and second register marks in their respective images, the image-capturing means captures an image of an edge of the print sheet together with the first register mark and also captures an image of the edge of the print sheet together with the second register mark, the print sheet already subjected to printing in the first and second printing sections, and the adjustment means adjusts any one of the position of the pattern to be printed in the first printing section and the position of the pattern to be printed in the second printing section, on the basis of the position of the first register mark in the image, a position of the edge of the print sheet in the image captured together with the first register mark, the position of the second register mark in the image, and a position of the edge of the print sheet in the image captured together with the second register mark.

The register apparatus of the printing press according to a fourth aspect of the invention to solve the aforementioned problems is the register apparatus of the printing press according to the first aspect of the invention, wherein the registration is position alignment in a lateral direction.

The register apparatus of the printing press according to a fifth aspect of the invention to solve the aforementioned problems is the register apparatus of the printing press according to the first aspect of the invention, wherein the registration is position alignment n a circumferential direction.

The register apparatus of the printing press according to a sixth aspect of the invention to solve the aforementioned problems is the register apparatus of the printing press according to the first aspect of the invention, wherein the registration is position alignment in a skewing direction.

A register method for a printing press according to a seventh aspect to solve the aforementioned problems is a register method for a printing press including a printing section to print a pattern and having a register apparatus that captures an image of a register mark printed in the printing section and causes a position of the pattern, which are to be printed in the printing section, to be in register on the basis of a position of the register mark in the image, the register method comprising: capturing an image of an edge of a print sheet together with the register mark, the print sheet already subjected to printing in the printing section; and adjusting the position of the pattern to be printed in the printing section, on the basis of the position of the register mark in the image and a position of the edge of the print sheet in the image.

The register method for the printing press according to an eighth aspect of the invention to solve the aforementioned problems is the register method for the printing press according to the seventh aspect of the invention, wherein, the printing press includes a first printing section to print a pattern of a first color and a second printing section to print a pattern of a second color different from the first color, the register apparatus of the printing press captures an image of a first register mark and a second register mark printed respectively in the first and second printing sections, the register apparatus of the printing press causes positions of the patterns, which are to be printed respectively in the first and second printing sections, to be in register on the basis of positions the first and second register marks in the image, capturing an image of an edge of a print sheet together with the first and second register marks, the print sheet already subjected to printing in the first and second printing sections, and any one of the position of the pattern to be printed in the first printing section and the position of the pattern to be printed in the second printing section is adjusted based on the position of the first register mark in the image, the position of the second register mark in the image, and a position of the edge of the print sheet in the image.

The register method for the printing press according to a ninth aspect of the invention to solve the aforementioned problems is the register method for the printing press according to the seventh aspect of the invention, wherein, the printing press includes a first printing section to print a pattern on a front surface of a print sheet and a second printing section to print a pattern on aback surface of the print sheet, or a first printing section to print a pattern on back a surface of a print sheet and a second printing section to print a pattern on a front surface of the print sheet, the register apparatus of the printing press captures an image of a first register mark and an image of a second register mark printed respectively in the first and second printing sections, the register apparatus of the printing press causes positions of the patterns, which are to be printed respectively in the first and second printing sections, to be in register on the basis of positions of the first and second register marks in their respective images, capturing an image of an edge of the print sheet together with the first register mark, the print sheet already subjected to printing in the first and second printing sections, and capturing an image of the edge of the print sheet together with the second register mark, the print sheet already subjected to printing in the first and second printing sections, and adjusting any one of the position of the pattern to be printed in the first printing section and the position of the pattern to be printed in the second printing section, on the base of the position of the first register mark in the image, a position of the edge of the print sheet in the image captured together with the first register mark, the position of the second register mark in the image, and a position of the edge of the print sheet in the image captured together with the second register mark.

The register method for the printing press according to a tenth aspect of the invention to solve the aforementioned problems is the register method for the printing press according to the seventh aspect of the invention, wherein the registration is position alignment in a lateral direction.

The register method for the printing press according to an eleventh aspect of the invention to solve the aforementioned problems is the register method for the printing press according to the seventh aspect of the invention, wherein the registration is position alignment in a circumferential direction.

The register method for the printing press according to a twelfth aspect of the invention to solve the aforementioned problems is the register method for the printing press according to the seventh aspect of the invention, wherein the registration is position alignment in a skewing direction.

### Advantageous Effects of Invention

According to the present invention, it is possible to provide a register apparatus of a printing press and a register method for the printing press, with which registration can be performed correctly and accurately for each color and between the front and back surfaces.

### BRIEF DESCRIPTION OF DRAWINGS

FIG. 1A is a block diagram showing the configuration of a register apparatus of a printing press according a first example.

FIG. 1B is a block diagram following FIG. 1A and showing the configuration of the register apparatus of the printing press according to the first example.

FIG. 1C is a block diagram following FIG. 1B and showing the configuration of the register apparatus of the printing press according to the first example.

FIG. 2A is an operation flowchart showing the procedure of processing involving the register apparatus of the printing press and a register method for the printing press according to the first example.

FIG. 2B is an operation flowchart following FIG. 2A and showing the procedure in the processing involving the register apparatus of the printing press and the register method for the printing press according to the first example.

FIG. 2C is an operation flowchart following FIG. 2B and showing the procedure in the processing involving the register apparatus of the printing press and the register method for the printing press according to the first example.

FIG. 3 is a schematic diagram showing the configuration of a main part of the register apparatus of the printing press according to the first example.

FIG. 4 is a schematic diagram showing an example of the printing press according to the first example.

FIG. 5A is a block diagram showing the configuration of a register apparatus of a printing press according a second example.

FIG. 5B is a block diagram following FIG. 5A and showing the configuration of the register apparatus of the printing press according to the second example.

FIG. 5C is a block diagram following FIG. 5B and showing the configuration of the register apparatus of the printing press according to the second example.

FIG. 6A is an operation flowchart showing the procedure of processing involving the register apparatus of the printing press and a register method for the printing press according to the second example.

FIG. 6B is an operation flowchart following FIG. 6A and showing the procedure in the processing involving the register apparatus of the printing press and the register method for the printing press according to the second example.

FIG. 6C is an operation flowchart following FIG. 6B and showing the procedure in the processing involving the register apparatus of the printing press and the register method for the printing press according to the second example.

FIG. 7 is a perspective diagram showing the configuration of a main part of the register apparatus of the printing press according to the second example.

FIG. 8 is a schematic diagram showing an example of the printing press according to the second example.

FIG. 9 is a schematic diagram showing an example of the printing press according to the second example.

### DESCRIPTION OF EMBODIMENTS

Hereinbelow, embodiments of a register apparatus of a printing press and a register method for the printing press according to the present invention will be described by referring to the drawings.

### First Example

In the following, a first example of the register apparatus of the printing press and the register method for the printing press according to the present invention will be described.

Firstly, an overview of the configuration of the printing press according to the first example will be described.

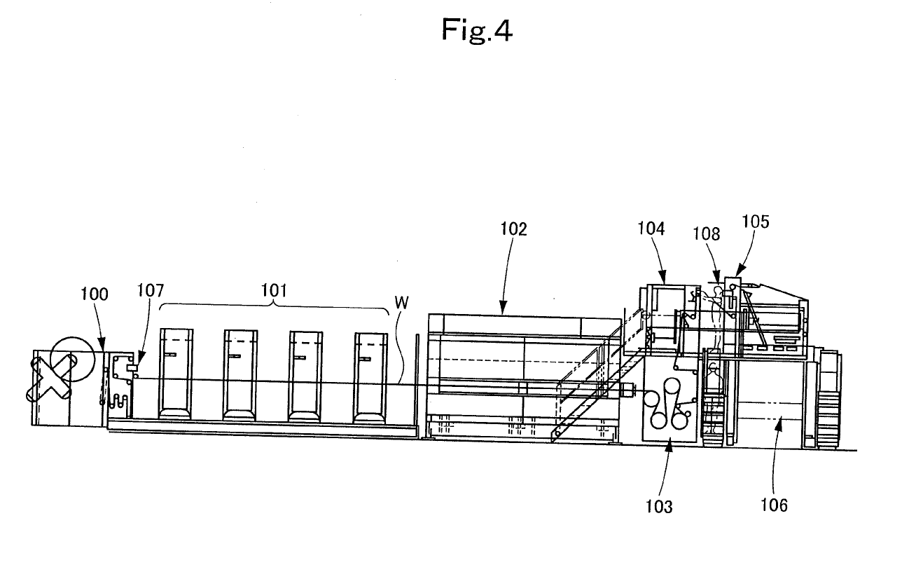

FIG. 4 is a schematic diagram showing an example of the printing press according to the first example.

As shown in FIG. 4, in a four-color web-fed double-sided rotary printing press as the printing press according to the first example, a web W fed seamlessly from a feeding unit 100 is subjected to printing of several colors while passing through double-sided printing units 101 of four colors, namely, yellow (Y), magenta (M), cyan (C) and black (K). The web W is then heated and dried while passing through a drying unit 102 and thereafter cooled while passing through a cooling unit 103. Subsequently, the web W is subjected to tension control or directional change while passing through a web path unit 104 and a dragging unit 105, and finally cut in a predetermined shape and folded by a folding unit 106. Meanwhile, a web guiding unit 107 is provided upstream of the drying unit 102 (in the illustrated example, provided to the feeding unit 100), and a web guiding unit 108 is provided downstream of the drying unit 102 (in the illustrated example, provided to the dragging unit 105).

The above is the overview of the configuration of the printing press according to the first example.

Next, the configuration of the register apparatus of the printing press according to the first example will be described.

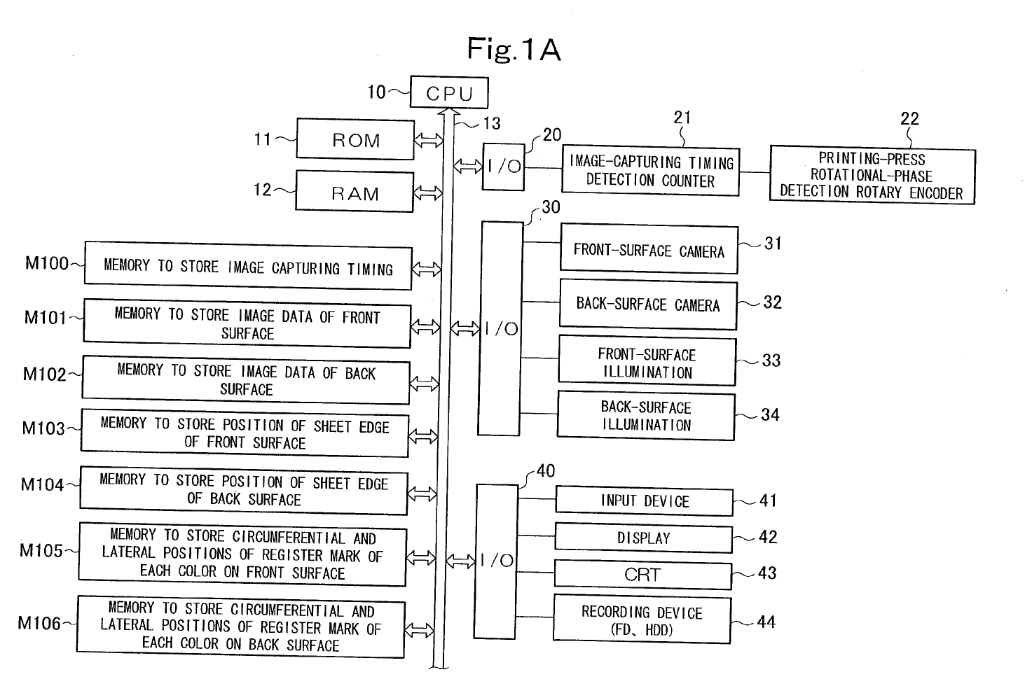

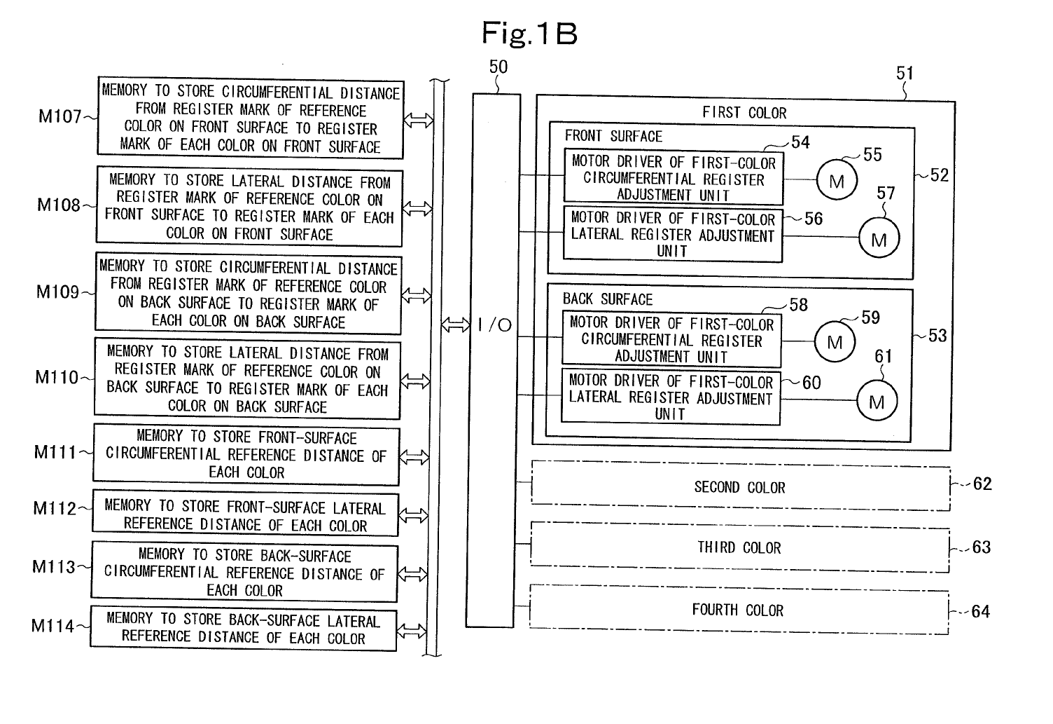

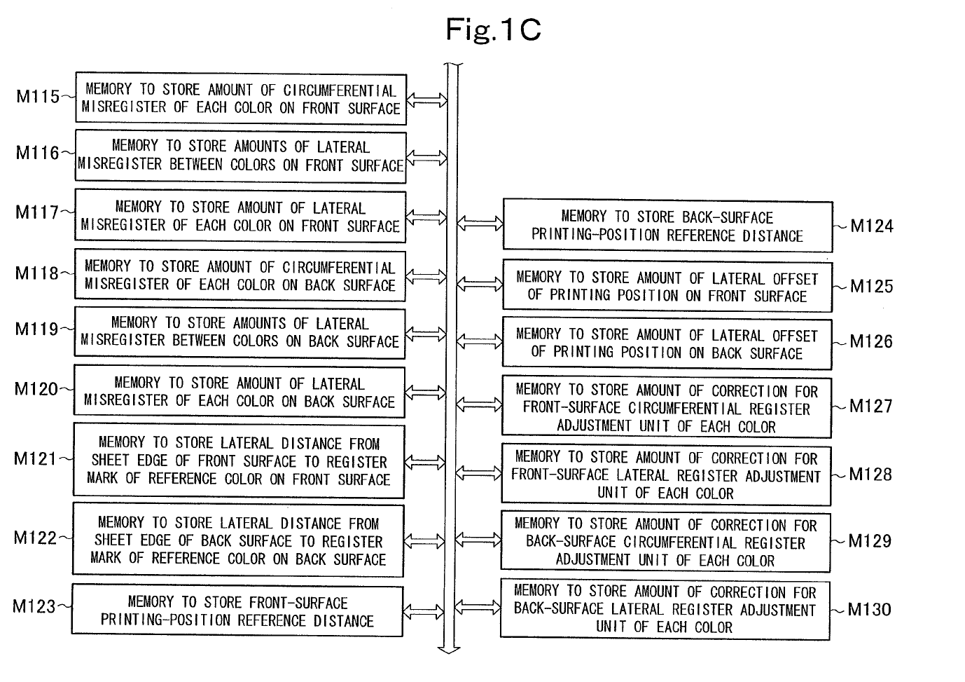

FIGS. 1A to 1C are block diagrams showing the configuration of the register apparatus of the printing press according to the first example.

As shown in FIGS. 1A to 1C, the register apparatus of the printing press according to the first example includes, on a bus 13, a CPU 10, a ROM 11, a RAM 12 and input/output devices (hereinafter, referred to as “I/Os”) 20, 30, 40 and 50.

Through the I/O 20, the register apparatus of the printing press according to the first example is provided with a counter 21 for detecting image-capturing timing (hereinafter, referred to as “image-capturing timing detection counter”) and a rotary encoder 22 for detecting the rotational phase in the printing press (hereinafter, referred to as “printing-press rotational-phase detection rotary encoder”). Note that the printing-press rotational-phase detection rotary encoder 22 is attached to a rotary member of the printing press and outputs a clock pulse to the image-capturing timing detection counter 21 every time a turning movement of a given angle is made in the printing press. Moreover, the printing-press rotational-phase detection rotary encoder 22 outputs a zero pulse once to the image-capturing timing detection counter 21 every time one complete rotation, which is based on a reference rotational phase of the printing press, is made in the printing press. Such output resets the image-capturing timing detection counter 21. Thus, the image-capturing timing detection counter 21 counts the clock pulse from the printing-press rotational-phase detection rotary encoder 22 that is based on the reference rotational phase of the printing press, and the count value indicates the current rotational phase of the printing press.

Moreover, through the I/O 30, the register apparatus of the printing press according to the first example is provided with a front-surface camera 31, a back-surface camera 32, a front-surface illumination 33 and a back-surface illumination 34.

Now, the configuration of a main part of the register apparatus of the printing press according to the first example will be described.

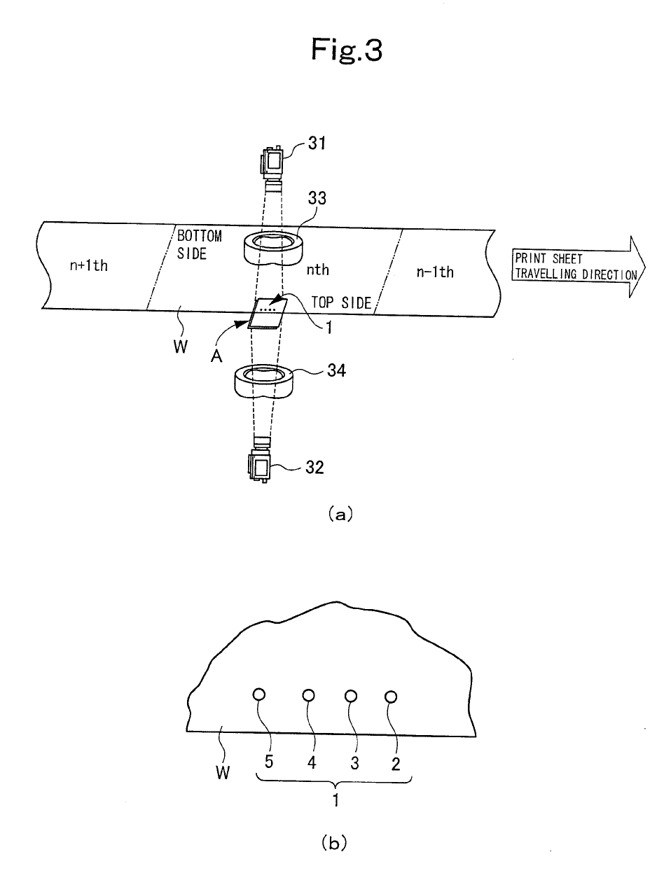

FIG. 3 is a schematic diagram showing the configuration of the main part of the register apparatus of the printing press according to the first example. Note that FIG. 3(a) is a schematic diagram showing the configuration of the main part of the register apparatus of the printing press according to the first example, whereas FIG. 3(b) is an enlarged diagram showing an example of register marks according to the first example.

As shown in FIG. 3(a), the register apparatus of the printing press according to the first example includes the front-surface camera 31 and the front-surface illumination 33, which are installed above the web W, and the back-surface camera 32 and the back-surface illumination 34, which are installed below the web W.

Moreover, as shown in FIG. 3(b), a register mark 1 to be used for registration is printed on each of the front and back surfaces of the web W near its left or right sheet edge. The register mark 1 is formed of a black register mark 2, a cyan register mark 3, a magenta register mark 4 and a yellow register mark 5. Note that FIG. 3(b) shows only the register mark 1 of each color for the front surface, but the register mark 1 of each color is also printed on the back surface of the web W at the same position.

As shown in FIG. 3(a), the front-surface camera 31 and the back-surface camera 32 each capture an image in such a way that its register mark 1 and sheet edge portion of the web W are included within an image capturing area A of a corresponding one of the front-surface camera 31 and the back-surface camera 32. Meanwhile, in the case of the first example, the black register mark 2 is used as a register mark of a reference color to calculate the amounts of misregister for each color and between the front and back surfaces.

Through the I/O 40, the register apparatus of the printing press according to the first example is provided with an input device 41, a display 42, a CRT 43 and a recording device (FD, HDD) 44.

Through the I/O 50, the register apparatus of the printing press according to the first example is also provided with a first-color register adjustment mechanism 51. This first-color register adjustment mechanism 51 includes a front-surface first-color register adjustment device 52 and a back-surface first-color register adjustment device 53.

The front-surface first-color register adjustment device 52 includes: a motor 55 of a front-surface first-color circumferential register adjustment unit; a motor driver 54 of the front-surface first-color circumferential register adjustment unit which controls the motor 55 of the front-surface first-color circumferential register adjustment unit; a motor 57 of a front-surface first-color lateral register adjustment unit; and a motor driver 56 of the front-surface first-color lateral register adjustment unit which controls the motor 57 of the front-surface first-color lateral register adjustment unit.

The back-surface first-color register adjustment device 53 includes: a motor 59 of a back-surface first-color circumferential register adjustment unit; a motor driver 58 of the back-surface first-color circumferential register adjustment unit which controls the motor 59 of the back-surface first-color circumferential register adjustment unit; a motor 61 of a back-surface first-color lateral register adjustment unit; and a motor driver 60 of the back-surface first-color lateral register adjustment unit which controls the motor 61 of the back-surface first-color lateral register adjustment unit.

The register apparatus of the printing press according to the first example further includes a second-color register adjustment mechanism 62, a third-color register adjustment mechanism 63 and a fourth-color register adjustment mechanism 64, all of which have the same configuration as that of the first-color register adjustment mechanism 51. Incidentally, a generally known structure is employed for each of the first-, second-, third- and fourth-color register adjustment mechanisms 51, 62, 63 and 64, and therefore description thereof is omitted herein (see Patent Literatures 1 and 2 listed above.)

On the bus 13, the register apparatus of the printing press according to the first example also includes: a memory M100 to store the image capturing timing; a memory M101 to store image data of the front surface; a memory M102 to store image data of the back surface; a memory M103 to store the position of a sheet edge of the front surface; a memory M104 to store the position of the sheet edge of the back surface; a memory M105 to store the circumferential and lateral positions of the register mark of each color on the front surface; a memory M106 to store the circumferential and lateral positions of the register mark of each color on the back surface; a memory M107 to store the circumferential distance from the register mark of the reference color on the front surface to the register mark of each color on the front surface; a memory M108 to store the lateral distance from the register mark of the reference color on the front surface to the register mark of each color on the front surface; a memory M109 to store the circumferential distance from the register mark of the reference color on the back surface to the register mark of each color on the back surface; a memory M110 to store the lateral distance from the register mark of the reference color on the back surface to the register mark of each color on the back surface; a memory M111 to store a front-surface circumferential reference distance of each color; a memory M112 to store a front-surface lateral reference distance of each color; a memory M113 to store aback-surface circumferential reference distance of each color; a memory M114 to store a back-surface lateral reference distance of each color; a memory M115 to store the amount of circumferential misregister of each color on the front surface; a memory M116 to store the amounts of lateral misregister between the colors on the front surface; a memory M117 to store the amount of lateral misregister of each color on the front surface; a memory M118 to store the amount of circumferential misregister of each color on the back surface; a memory M119 to store the amounts of lateral misregister between the colors on the back surface; a memory M120 to store the amount of lateral misregister of each color on the back surface; a memory M121 to store the lateral distance from the sheet edge of the front surface to the register mark of the reference color on the front surface; a memory M122 to store the lateral distance from the sheet edge of the back surface to the register mark of the reference color on the back surface; a memory M123 to store a reference distance for a printing position on the front surface (hereinafter, referred to as “front-surface printing-position reference distance”); a memory M124 to store a reference distance for a printing position on the back surface (hereinafter, referred to as “back-surface printing-position reference distance”); a memory M125 to store the amount of lateral offset of the printing position on the front surface; a memory M126 to store the amount of lateral offset of the printing position on the back surface; a memory M127 to store the amount of correction for the front-surface circumferential register adjustment unit of each color; a memory M128 to store the amount of correction for the front-surface lateral register adjustment unit of each color; a memory M129 to store the amount of correction for the back-surface circumferential register adjustment unit of each color; and a memory M130 to store the amount of correction for the back-surface lateral register adjustment unit of each color.

The above is the configuration of the register apparatus of the printing press according to the first example.

Next, description will be given of processing involving the register apparatus of the printing press and a register method for the printing press according to the first example.

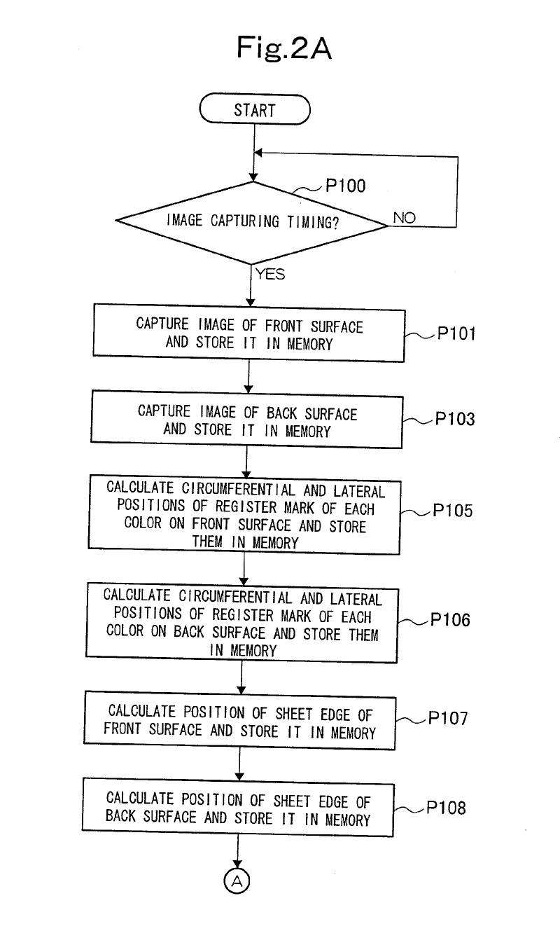

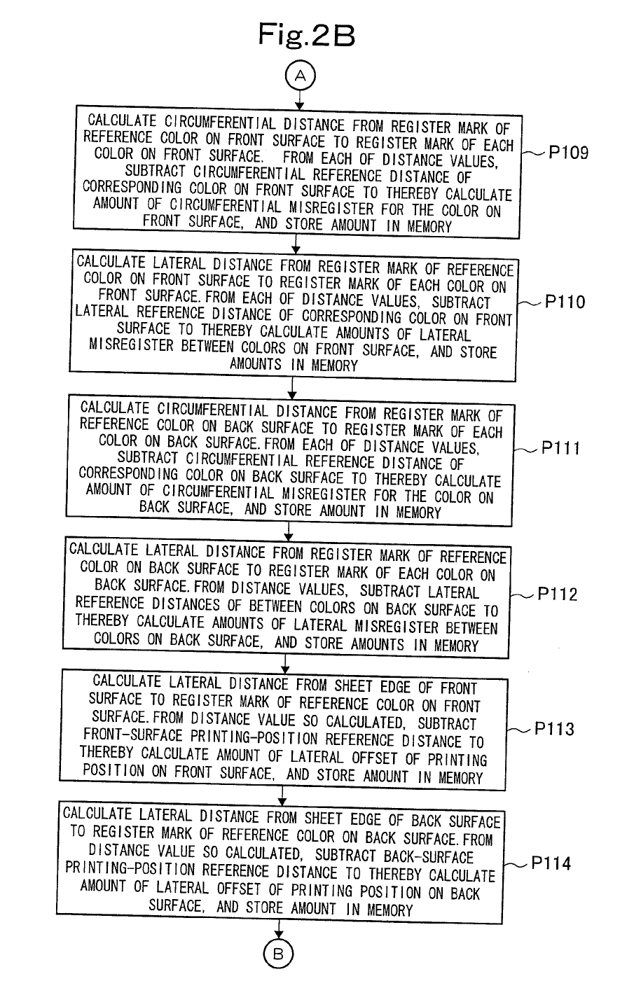

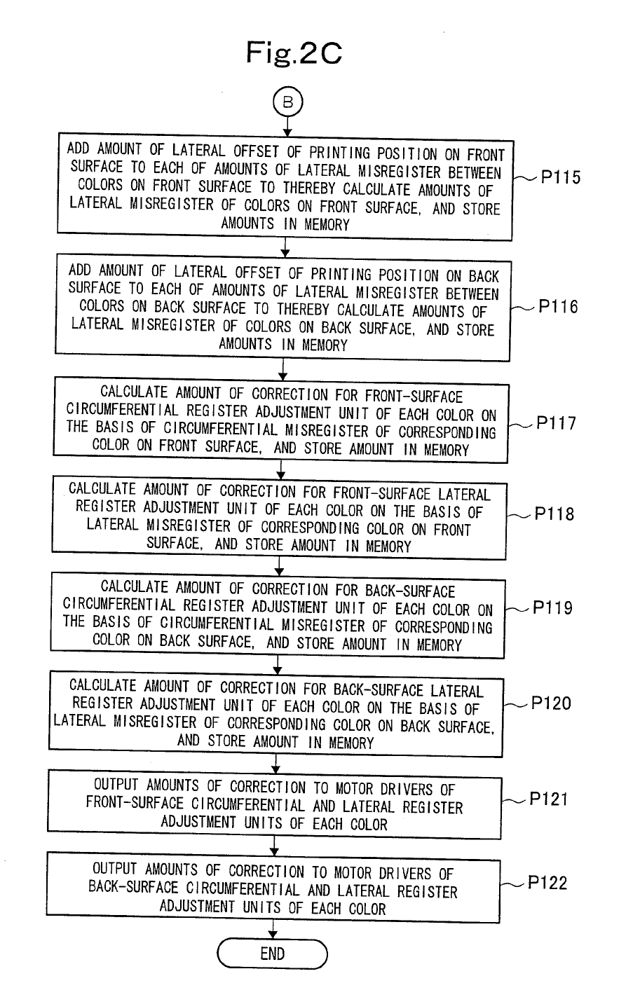

FIGS. 2A to 2C are operation flowcharts showing the procedure of processing involving the register apparatus of the printing press and the register method for the printing press according to the first example.

Meanwhile, the front-surface illumination 33 and the back-surface illumination 34 are turned on before the operation following the operation flow shown in FIGS. 2A to 2C is performed, and turned off when the register apparatus ends the operation.

As shown in FIGS. 2A to 2C, in Step P100, the CPU 10 compares the value of the image-capturing timing detection counter 21 with the value stored in the memory M100 to determine whether it is the timing to capture images.

If determining in Step P100 that it is the timing to capture images as a result of the comparison of the value of the image-capturing timing detection counter 21 with the value stored in the memory M100, the CPU 10 executes Step P101. On the other hand, if determining in Step P100 that it is not the timing to capture images as a result of the comparison of the value of the image-capturing timing detection counter 21 with the value stored in the memory M100, the CPU 10 executes Step P100 again.

In Step P101, the CPU 10 captures an image of the front surface and stores it in the memory M101. After completing the process in Step P101, the CPU 10 executes Step P103.

In Step P103, the CPU 10 captures an image of the back surface and stores it in the memory M102. After completing the process in Step P103, the CPU 10 executes Step P105.

In Step P105, the CPU 10 calculates the circumferential and lateral positions of the register mark of each color on the front surface and store them in the memory M105. After completing the process in Step P105, the CPU 10 executes Step P106.

In Step P106, the CPU 10 calculates the circumferential and lateral positions of the register mark of each color on the back surface and store them in the memory M106. After completing the process in Step P106, the CPU 10 executes Step P107.

In Steps P105 and P106, the circumferential and lateral positions of the register mark of each color on the front and back surfaces are calculated from the center position of the register mark of the corresponding color in the image data of the front and back surfaces, which is figured out through template matching. Incidentally, the template matching technique is one generally known, and thus description thereof is omitted herein (see Non-patent Literature 1 listed above).

In Step P107, the CPU 10 calculates the position of the sheet edge of the front surface and stores it in the memory M103. After completing the process in Step P107, the CPU 10 executes Step P108.

In Step P108, the CPU 10 calculates the position of the sheet edge of the back surface and stores it in the memory M104. After completing the process in Step P108, the CPU 10 executes Step P109.

In each of Steps P107 and P108, the position of the sheet edge is calculated as below. First, from each of multiple lateral lines arranged in the circumferential direction, differential values are obtained by applying a differential filter to the image data, and the largest value is determined from among the differential values thus obtained. Then, from differential values in the vicinity of the determined largest value, a formula that represents the distribution thereof is determined by use of the least square method, followed by the calculation of a peak value in the determined formula at which the differential value in the formula is zero. The lateral position of this peak value is then calculated. Next, from the lateral position of the calculated peak value of each line, a formula corresponding to the sheet edge line is determined by use of the least square method. Then, with the formula, the value of a circumferential position that is the same as the circumferential position of each register mark obtained in Step P105 or P106, i.e., lateral position, is set as the position of the sheet edge. Here, the edge extraction method with the differential filter is one generally known, and thus description thereof is omitted here (see Non-patent Literature 1 listed above).

In Step P109, the CPU 10 calculates the circumferential distance from the register mark of the reference color on the front surface to the register mark of each color on the front surface and stores it in the memory M107. From each of the distance value so calculated, the CPU 10 subtracts a circumferential reference distance for the corresponding color on the front surface stored in the memory M111 to thereby calculate the amount of circumferential misregister for the color on the front surface, and stores the amount in the memory M115. Note that the amount of circumferential misregister can be figured out from the circumferential distance after the subtraction, the magnification of the image-capturing camera, and the pitch of the CCD elements of the image-capturing camera. After completing the process in Step P109, the CPU 10 executes Step P110.

In Step P110, the CPU 10 calculates the lateral distance from the register mark of the reference color on the front surface to the register mark of each color on the front surface and stores it in the memory M108. From each of the distance values so calculated, the CPU 10 subtracts a lateral reference distance for the corresponding color on the front surface stored in the memory M112 to thereby calculate the amounts of lateral misregister between the colors on the front surface, and stores the amounts in the memory M116. After completing the process in Step P110, the CPU 10 executes Step P111.

In Step P111, the CPU 10 calculates the circumferential distance from the register mark of the reference color on the back surface to the register mark of each color on the back surface and stores it to the memory M109. From each of the distance values so calculated, the CPU 10 subtracts a circumferential reference distance for the corresponding color on the back surface stored in the memory M113 to thereby calculate the amount of circumferential misregister for the color on the back surface, and stores the amount in the memory M118. After completing the process in Step P111, the CPU 10 executes Step P112.

In Step P112, the CPU 10 calculates the lateral distance from the register mark of the reference color on the back surface to the register mark of each color on the back surface and stores it in the memory M110. From each of the distance values so calculated, the CPU 10 subtracts a lateral reference distance for the corresponding color on the back surface stored in the memory M114 to thereby calculate the amounts of lateral misregister between the colors on the back surface, and stores the amounts in the memory M119. After completing the process in Step P112, the CPU 10 executes Step P113.

In Step P113, the CPU 10 calculates the lateral distance from the sheet edge of the front surface to the register mark of the reference color on the front surface and stores it in the memory M121. From the distance value so calculated, the CPU 10 subtracts a front-surface printing-position reference distance stored in the memory M123 to thereby calculate the amount of lateral offset of the printing position on the front surface, and stores the amount in the memory M125. After completing the process in Step P113, the CPU 10 executes Step P114.

In Step P114, the CPU 10 calculates the lateral distance from the sheet edge of the back surface to the register mark of the reference color on the back surface and stores it in the memory M122. From the distance value so calculated, the CPU 10 subtracts a back-surface printing-position reference distance stored in the memory M124 to thereby calculate the amount of lateral offset of the printing position on the back surface, and stores the amount in the memory M126. After completing the process in Step P114, the CPU 10 executes Step P115.

In Step P115, the CPU 10 adds the amount of lateral offset of the printing position on the front surface to each of the amounts of lateral misregister between the colors on the front surface to thereby calculate the amounts of lateral misregister for the colors on the front surface, and stores the amounts in the memory M117. Note that each amount of lateral misregister can be figured out from the amount of lateral misregister after the addition, the magnification of the image-capturing camera, and the pitch of the CCD elements of the image-capturing camera. After completing the process in Step P115, the CPU 10 executes Step P116.

In Step P116, the CPU 10 adds the amount of lateral offset of the printing position on the back surface to each of the amounts of lateral misregister between the colors on the back surface to thereby calculate the amounts of lateral misregister for the colors on the back surface, and stores the amounts in the memory M120. After completing the process in Step P116, the CPU 10 executes Step P117.

In Step P117, the CPU 10 calculates the amount of correction for the front-surface circumferential register adjustment unit of each color on the basis of the circumferential misregister for the corresponding color on the front surface, and stores the amount in the memory M127. Note that the amount of correction for the circumferential register adjustment unit can be figured out from the amount of circumferential misregister figured out in Step P109 and the relationship between the amount of drive given to the motor of the circumferential register adjustment unit and the amount of circumferential movement the motor provides. After completing the process in Step P117, the CPU 10 executes Step P118.

In Step P118, the CPU 10 calculates the amount of correction for the front-surface lateral register adjustment unit of each color on the basis of the lateral misregister for the corresponding color on the front surface, and stores the amount in the memory M128. Note that the amount of correction for the lateral register adjustment unit can be figured out from the amount of lateral misregister figured out in Step P115 and the relationship between the amount of drive given to the motor of the lateral register adjustment unit and the amount of lateral movement the motor provides. After completing the process in Step P118, the CPU 10 executes Step P119.

In Step P119, the CPU 10 calculates the amount of correction for the back-surface circumferential register adjustment unit of each color on the basis of the circumferential misregister for the corresponding color on the back surface, and stores the amount in the memory M129. After completing the process in Step P119, the CPU 10 executes Step P120.

In Step P120, the CPU 10 calculates the amount of correction for the back-surface lateral register adjustment unit of each color on the basis of the lateral misregister for the corresponding color on the back surface, and stores the amount in the memory M130. After completing the process in Step P120, the CPU 10 executes Step P121.

In Step P121, the CPU 10 outputs the amounts of correction to the motor drivers of the front-surface circumferential and lateral register adjustment units of each color. After completing the process in Step P121, the CPU 10 executes Step P122.

In Step P122, the CPU 10 outputs the amounts of correction to the motor drivers of the back-surface circumferential and lateral register adjustment units of each color. By driving the motors of the front- and back-surface circumferential and lateral register adjustment units of each color in the above-described manner, the positions of patterns to be printed by the respective printing units are adjusted. After completing the process in Step P121, the CPU 10 ends the series of processes and repeats the operation flow until receiving a command to end the control.

The above is the procedure of the processing involving the register apparatus of the printing press and the register method for the printing press according to the first example.

In the following, a second example of the register apparatus of the printing press and the register method for the printing press according to the present invention will be described.

Firstly, an overview of the configuration of the printing press according to the second example will be described.

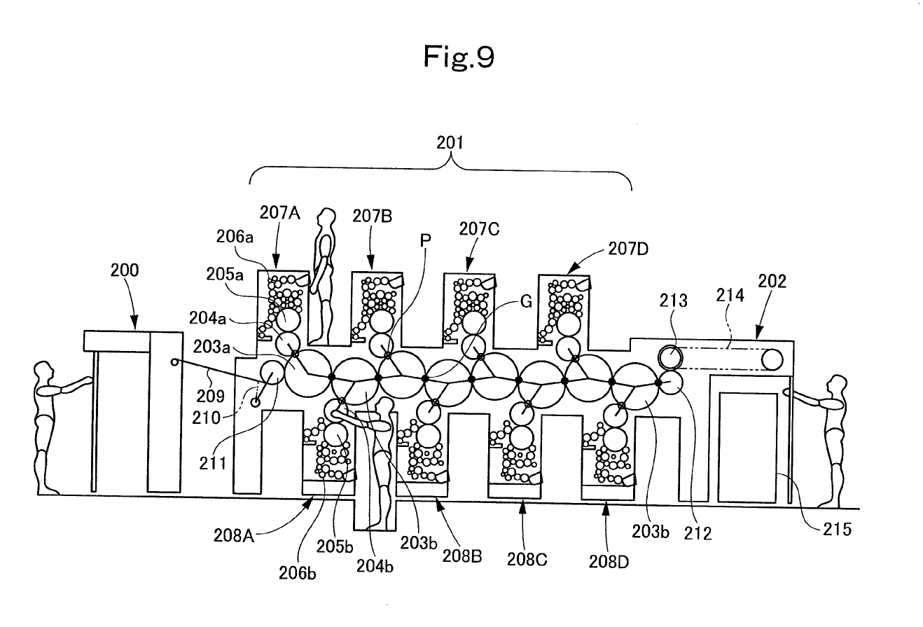

FIG. 9 is a schematic diagram showing an example of the printing press according to the first example.

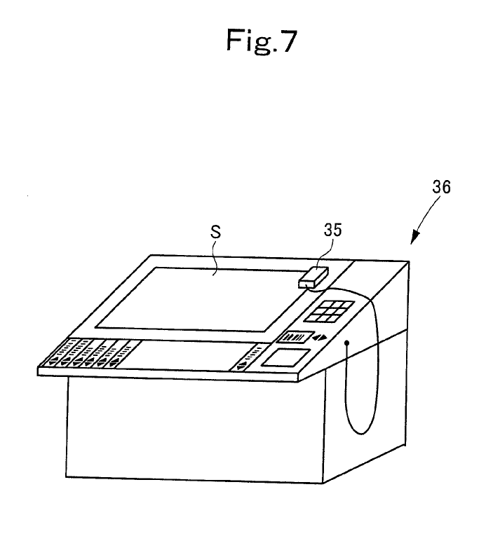

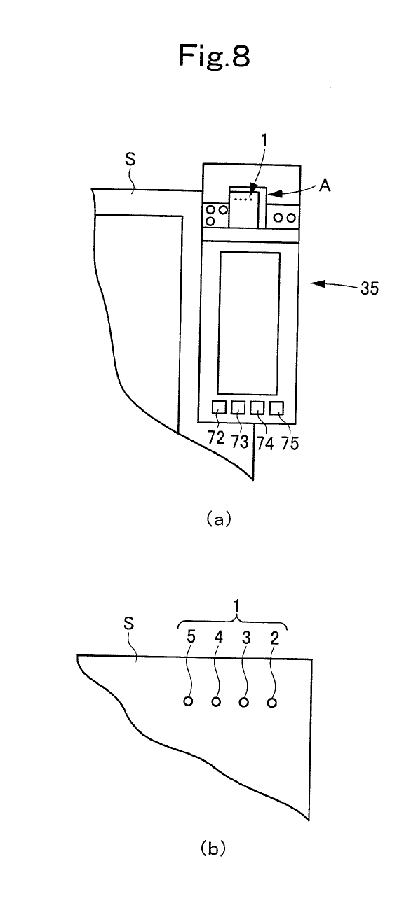

A four-color sheet-fed double-sided rotary printing press in FIG. 9 as the printing press according to the second example is formed of a feeding section 200, a printing section 201 and a delivery section 202. An impression cylinder 203a which appears first in the printing section 201 is fed with paper sheets S (see FIGS. 7 and 8) through a feeder board 209, a swing gripper device 210 and a transfer cylinder 211, the paper sheets S piled up in the feeding section 200. From an impression cylinder 203b which appears last in the printing section 201, the paper sheets S having been subjected to printing are passed over to a delivery cylinder 213 in the delivery section 202 through a transport cylinder 212. From there, the paper sheets S are delivered onto a pile board of a pile raising and lowering device 215 by a chain gripper 214.

The printing section 201 is formed of four front-surface printing units 207A to 207D and four back-surface printing units 208A to 208D. The front-surface printing units 207A to 207D responsible respectively for first to fourth colors are each formed by providing a blanket cylinder 204a, a plate cylinder 205a and an inker 206a sequentially on an upper portion of the impression cylinder 203a given a sheet gripper. The back-surface printing units 208A to 208D responsible respectively for the first to fourth colors are each formed by providing a blanket cylinder 204b, a plate cylinder 205b and an inker 206b sequentially on a lower portion of the impression cylinder 203b given a sheet gripper.

Meanwhile, the impression cylinders 203a of the four front-surface printing units 207A to 207D and the impression cylinders 203b of the four back-surface printing units 208A to 208D have diameters twice as large as those of their adjacent plate cylinders 205a and 205b. Note that P and G in FIG. 9 denote the printing position and the gripping change position, respectively. Further, the first to fourth colors in the second example correspond to four colors, namely, yellow (Y), magenta (M), cyan (C) and black (K), respectively.

The above is the overview of the configuration of the printing press according to the second example.

Next, the configuration of the register apparatus of the printing press according to the second example will be described.

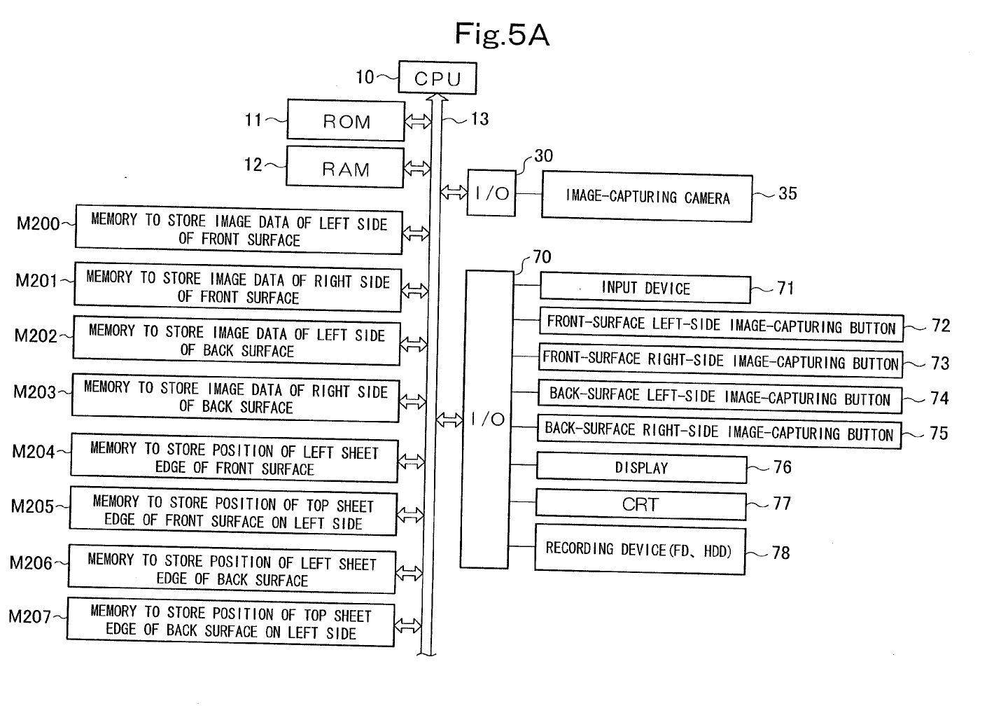

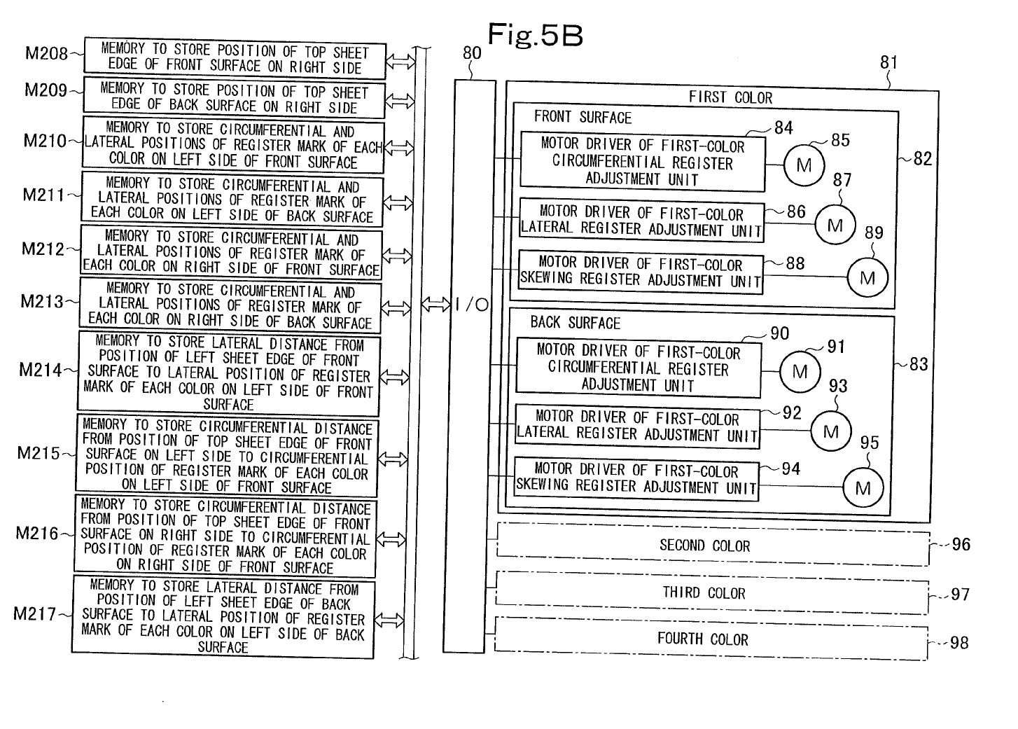

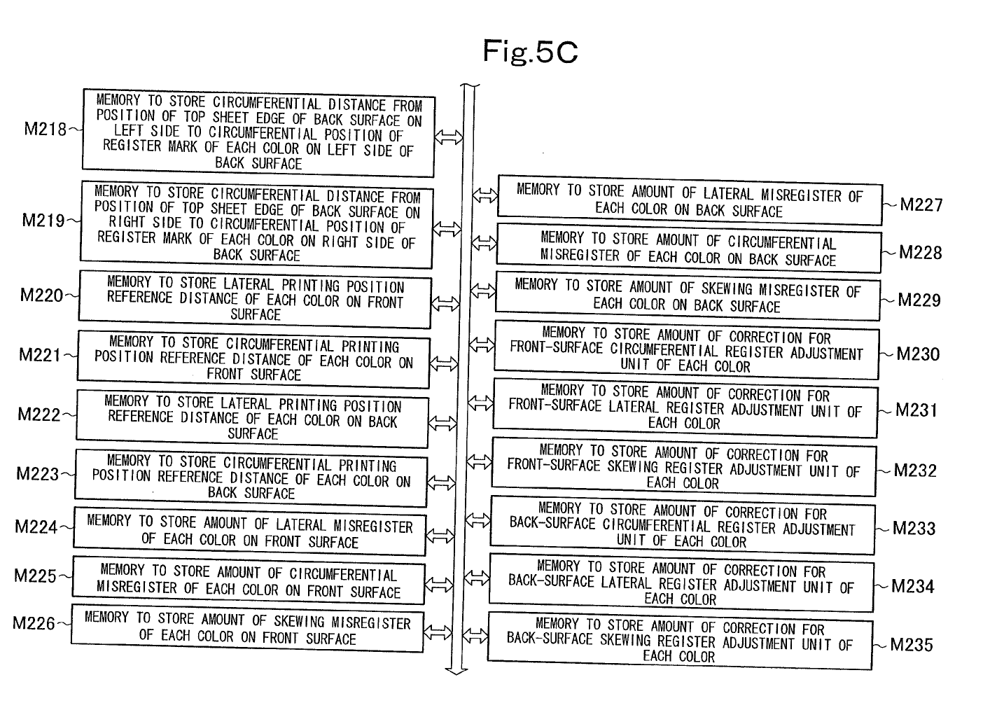

FIGS. 5A to 5C are block diagrams showing the configuration of the register apparatus of the printing press according to the second example.

As shown in FIGS. 5A to 5C, the register apparatus of the printing press according to the second example includes, on a bus 13, a CPU 10, a ROM 11, a RAM 12 and I/Os 30, 70 and 80.

Through the I/O 30, the register apparatus of the printing press according to the second example is provided with an image-capturing camera 35.

Through the I/O 70, the register apparatus of the printing press according to the second example is also provided with an input device 71, a button 72 for capturing an image of a left side of the front surface (hereinafter, referred to as “front-surface left-side image-capturing button”), a front-surface right-side image-capturing button 73, a back-surface left-side image-capturing button 74, a back-surface right-side image-capturing button 75, a display 76, a CRT 77, a recording device (FD, HDD) 78.

Now, the configuration of a main part of the register apparatus of the printing press according to the second example will be described.

FIG. 7 is a perspective view showing the configuration of the main part of the register apparatus of the printing press according to the second example.

Moreover, FIG. 8 is a schematic diagram showing the configuration of the main part of the register apparatus of the printing press according to the second example. Note that FIG. 8(a) is a schematic diagram showing the configuration of the main part of the register apparatus of the printing press according to the second example, whereas FIG. 8(b) is an enlarged diagram showing an example of register marks according to the second example.

As shown in FIGS. 7 and 8(a), the register apparatus of the printing press according to the second example includes the image-capturing camera 35 which the operator places on a paper sheet S over a color check table 36. As shown in FIG. 8(a), the image-capturing camera 35 includes the front-surface left-side image-capturing button 72, the front-surface right-side image-capturing button 73, the back-surface left-side image-capturing button 74 and the back-surface right-side image-capturing button 75. Note that the image-capturing camera 35 includes an illumination therein so that it can capture images.

As shown in FIG. 8(b), a register mark 1 to be used for registration is printed on left and right sheet edge portions of the paper sheet S near the top side thereof. The register mark 1 is formed of a black register mark 2, a cyan register mark 3, a magenta register mark 4 and a yellow register mark 5 and is printed on the front and back surfaces of the paper sheet S.

As shown in FIG. 8(a), an image is so captured that the register mark 1 and a sheet edge portion of the paper sheet S are included within an image-capturing area A of the image-capturing camera 35. Specifically, in the second example, the front-surface left-side image-capturing button 72 is pushed with the register mark 1 on the left side of the front surface and a sheet edge portion of the paper sheet S being included within the image-capturing area A. The front-surface right-side image-capturing button 73 is pushed with the register mark 1 on the right side of the front surface and a sheet edge portion of the paper sheet S being included within the image-capturing area A. The back-surface left-side image-capturing button 74 is pushed with the register mark 1 on the left side of the back surface and a sheet edge portion of the paper sheet S being included within the image-capturing area A. The back-surface right-side image-capturing button 75 is pushed with the register mark 1 on the right side of the back surface and a sheet edge portion of the paper sheet S being included within the image-capturing area A.

In the second example, the image-capturing camera 35 includes the front-surface left-side image-capturing button 72, the front-surface right-side image-capturing button 73, the back-surface left-side image-capturing button 74 and the back-surface right-side image-capturing button 75. Note, however, that it is possible to employ a configuration where the image-capturing camera 35 captures an image of each register mark 1 with a single image-capturing button by previously determining the order of capturing images for the register marks 1 on the left side of the front surface, the right side of the front surface, the left side of the back surface, and the right side of the back surface.

Through the I/O 80, the register apparatus of the printing press according to the second example is provided with a first-color register adjustment mechanism 81. This first-color register adjustment mechanism 81 includes a front-surface first-color register adjustment mechanism 82 and a back-surface first-color register adjustment mechanism 83.

The front-surface first-color register adjustment device 82 includes: a motor 85 of a front-surface first-color circumferential register adjustment unit; a motor driver 84 of the front-surface first-color circumferential register adjustment unit which controls the motor 85 of the front-surface first-color circumferential register adjustment unit; a motor 87 of a front-surface first-color lateral register adjustment unit; a motor driver 86 of the front-surface first-color lateral register adjustment unit which controls the motor 87 of the front-surface first-color lateral register adjustment unit; a motor 89 of a front-surface first-color skewing register adjustment unit; and a motor driver 88 of the front-surface first-color skewing register adjustment unit which controls the motor 89 of the front-surface first-color skewing register adjustment unit.

The back-surface first-color register adjustment device 83 includes: a motor 91 of a back-surface first-color circumferential register adjustment unit; a motor driver 90 of the back-surface first-color circumferential register adjustment unit which controls the motor 91 of the back-surface first-color circumferential register adjustment unit; a motor 93 of a back-surface first-color lateral register adjustment unit; a motor driver 92 of the back-surface first-color lateral register adjustment unit which controls the motor 93 of the back-surface first-color lateral register adjustment unit; a motor 95 of a back-surface first-color skewing register adjustment unit; and a motor driver 88 of the back-surface first-color skewing register adjustment unit which controls the motor 94 of the back-surface first-color skewing register adjustment unit.

The register apparatus of the printing press according to the first example further includes a second-color register adjustment mechanism 96, a third-color register adjustment mechanism 97 and a fourth-color register adjustment mechanism 98, all of which have the same configuration as that of the first-color register adjustment mechanism 81. Incidentally, a generally known structure is employed for each of the first-, second-, third- and fourth-color register adjustment mechanisms 81, 96, 97 and 98, and therefore description thereof is omitted herein (see Patent Literatures 1 and 2 listed above.)

On the bus 13, the register apparatus of the printing press according to the second example includes: a memory M200 to store image data of the left side of the front surface; a memory M201 to store image data of the right side of the front surface; a memory M202 to store image data of the left side of the back surface; a memory M203 to store image data of the right side of the back surface; a memory M204 to store the position of a left sheet edge of the front surface; a memory M205 to store the position of a top sheet edge of the front surface on the left side; a memory M206 to store the position of a left sheet edge of the back surface; a memory M207 to store the position of a top sheet edge of the back surface on the left side; a memory M208 to store the position of a top sheet edge of the front surface on the right side; a memory M209 to store the position of a top sheet edge of the back surface on the right side; a memory M210 to store the circumferential and lateral positions of the register mark of each color on the left side of the front surface; a memory M211 to store the circumferential and lateral positions of the register mark of each color on the left side of the back surface; a memory M212 to store the circumferential and lateral positions of the register mark of each color on the right side of the front surface; a memory M213 to store the circumferential and lateral positions of the register mark of each color on the right side of the back surface; a memory M214 to store the lateral distance from the position of the left sheet edge of the front surface to the lateral position of the register mark of each color on the left side of the front surface; a memory M215 to store the circumferential distance from the position of the top sheet edge of the front surface on the left side to the circumferential position of the register mark of each color on the left side of the front surface; a memory M216 to store the circumferential distance from the position of the top sheet edge of the front surface on the right side to the circumferential position of the register mark of each color on the right side of the front surface; a memory M217 to store the lateral distance from the position of the left sheet edge of the back surface to the lateral position of the register mark of each color on the left side of the back surface; a memory M218 to store the circumferential distance from the position of the top sheet edge of the back surface on the left side to the circumferential position of the register mark of each color on the left side of the back surface; a memory M219 to store the circumferential distance from the position of the top sheet edge of the back surface on the right side to the circumferential position of the register mark of each color on the right side of the back surface; a memory M220 to store a lateral printing position reference distance of each color on the front surface; a memory M221 to store a circumferential printing position reference distance of each color on the front surface; a memory M222 to store a lateral printing position reference distance of each color on the back surface; a memory M223 to store a circumferential printing position reference distance of each color on the back surface; a memory M224 to store the amount of lateral misregister of each color on the front surface; a memory M225 to store the amount of circumferential misregister of each color on the front surface; a memory M226 to store the amount of skewing misregister of each color on the front surface; a memory M227 to store the amount of lateral misregister of each color on the back surface; a memory M228 to store the amount of circumferential misregister of each color on the back surface; a memory M229 to store the amount of skewing misregister of each color on the back surface; a memory M230 to store the amount of correction for the front-surface circumferential register adjustment unit of each color; a memory M231 to store the amount of correction for the front-surface lateral register adjustment unit of each color; a memory M232 to store the amount of correction for the front-surface skewing register adjustment unit of each color; a memory M233 to store the amount of correction for the back-surface circumferential register adjustment unit of each color; a memory M234 to store the amount of correction for the back-surface lateral register adjustment unit of each color; and a memory M235 to store the amount of correction for the back-surface skewing register adjustment unit of each color.

The above is the configuration of the register apparatus of the printing press according to the second example.

Next, description will be given of processing involving the register apparatus of the printing press and a register method for the printing press according to the first example.

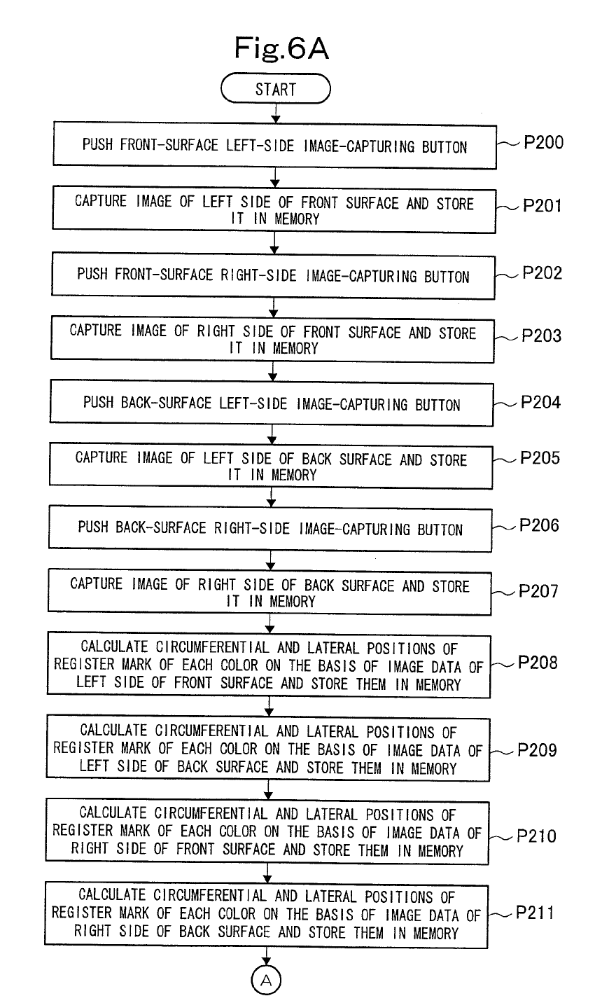

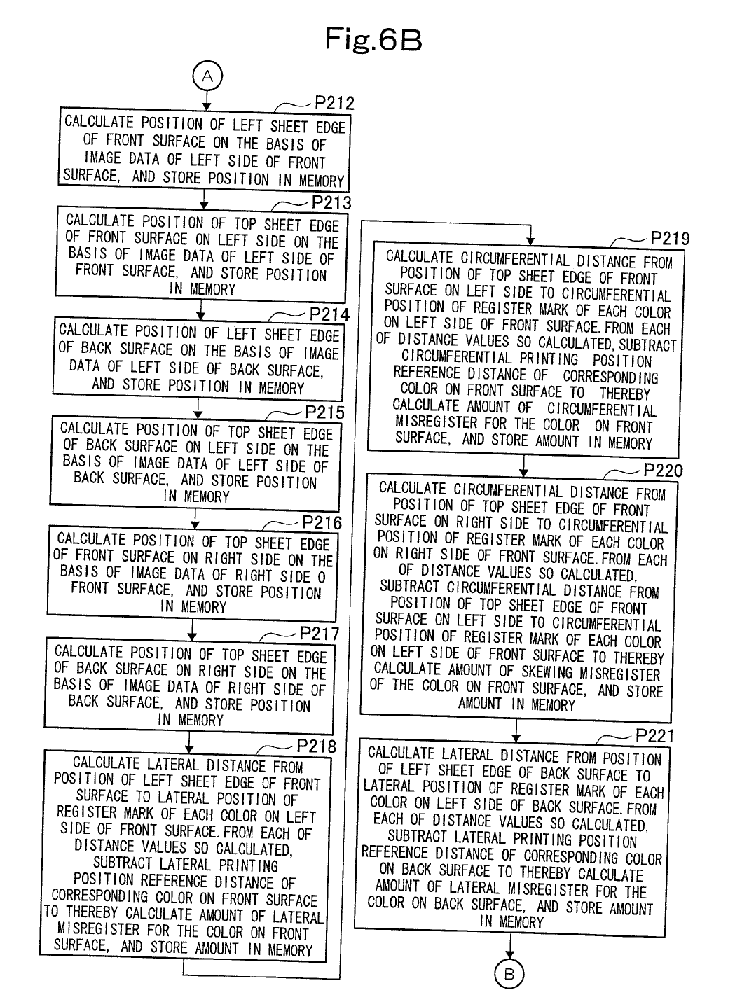

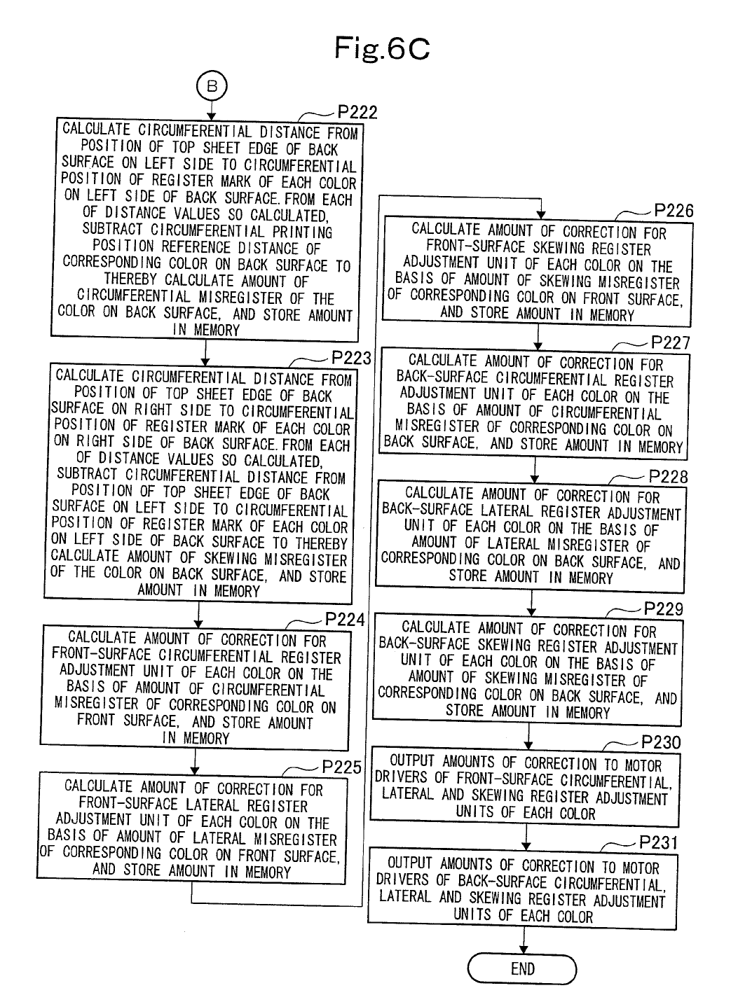

FIGS. 6A to 6C are operation flowcharts showing the procedure of processing involving the register apparatus of the printing press and the register method for the printing press according to the second example.

As shown in FIGS. 6A to 6C, after the operator places a paper sheet S, which has been subjected to printing by the four-color sheet-fed double-sided rotary printing press, onto the color check table 36 with the front surface up, the operator in Step P200 moves the image-capturing camera 35 to a position above the register mark on the left side of the front surface and pushes the front-surface left-side image-capturing button 72. In response to this, in Step P201, the CPU 10 captures an image of the left side of the front surface by use of the image-capturing camera 35 and stores it in the memory M200. After completing the process in Step P201, the CPU 10 executes Step P202.

In Step P202, the operator moves the image-capturing camera 35 to a position above the register mark on the right side of the front surface and pushes the front-surface right-side image-capturing button 73. In response to this, in Step P203, the CPU 10 captures an image of the right side of the front surface by use of the image-capturing camera 35 and stores it in the memory M201. After completing the process in Step P203, the CPU 10 executes Step P204.

In Step P204, after the operator flips and places the paper sheet S on the color check table 36 with the back surface up, the operator moves the image-capturing camera 35 to a position above the register mark on the left side of the back surface and pushes the back-surface left-side image-capturing button 74. In response to this, in Step P205, the CPU 10 captures an image of the left side of the back surface and stores it in the memory M202. After completing the process in Step P205, the CPU 10 executes Step P206.

In Step P206, the operator moves the image-capturing camera 35 to a position above the register mark on the right side of the back surface and pushes the back-surface right-side image-capturing button 73. In response to this, in Step P207, the CPU 10 captures an image of the right side of the back surface by use of the image-capturing camera 35 and stores it in the memory M203. After completing the process in Step P207, the CPU 10 executes Step P208.

In Step P208, based on the image data of the left side of the front surface, the CPU 10 calculates the circumferential and lateral positions of the corresponding register mark of each color and stores them in the memory M210. After completing the process in Step P208, the CPU 10 executes Step P209.

In Step P209, based on the image data of the left side of the back surface, the CPU 10 calculates the circumferential and lateral positions of the corresponding register mark of each color and stores them in the memory M211. After completing the process in Step P209, the CPU 10 executes Step P210.

In Step P210, based on the image data of the right side of the front surface, the CPU 10 calculates the circumferential and lateral positions of the corresponding register mark of each color and stores them in the memory M212. After completing the process in Step P210, the CPU 10 executes Step P211.

In Step P211, based on the image data of the right side of the back surface, the CPU 10 calculates the circumferential and lateral positions of the corresponding register mark of each color and stores them in the memory M213. After completing the process in Step P211, the CPU 10 executes Step P212.

In Steps P208 to P211, the circumferential and lateral positions of the register mark of each color on the front and back surfaces are calculated from the center position of the register mark of the corresponding color in the image data of the front and back surfaces, which is figured out through template matching. Incidentally, the template matching technique is one generally known, and thus description thereof is omitted herein (see Non-patent Literature 1 listed above).

In Step P212, the CPU 10 calculates the position of the left sheet edge of the front surface on the basis of the image data of the left side of the front surface, and stores the position in the memory M204. After completing the process in Step P212, the CPU 10 executes Step P213.

In Step P213, the CPU 10 calculates the position of the top sheet edge of the left side of the front surface on the basis of the image data of the left side of the front surface, and stores the position in the memory M205. After completing the process in Step P213, the CPU 10 executes Step P214.

In Step P214, the CPU 10 calculates the position of the left sheet edge of the back surface on the basis of the image data of the left side of the back surface, and stores the position in the memory M206. After completing the process in Step P214, the CPU 10 executes Step P215.

In Step P215, the CPU 10 calculates the position of the top sheet edge of the left side of the back surface on the basis of the image data of the left side of the back surface, and stores the position in the memory M207. After completing the process in Step P215, the CPU 10 executes Step P216.

In Step P216, the CPU 10 calculates the position of the top sheet edge of the right side of the front surface on the basis of the image data of the right side of the front surface, and stores the position in the memory M208. After completing the process in Step P216, the CPU 10 executes Step P217.

In Step P217, the CPU 10 calculates the position of the top sheet edge of the right side of the back surface on the basis of the image data of the right side of the back surface, and stores the position in the memory M209. After completing the process in Step P217, the CPU 10 executes Step P218.

In each of Steps P212 and P214, the position of the left sheet edge is calculated as below. First, from each of multiple lateral lines arranged in the circumferential direction, differential values are obtained by applying a differential filter to the image data, and the largest value is determined from among the differential values thus obtained. Then, from differential values in the vicinity of the determined largest value, a formula that represents the distribution thereof is determined by use of the least square method, followed by the calculation of a peak value in the determined formula at which the differential value in the formula is zero. The lateral position of this peak value is then calculated. Next, from the lateral position of the calculated peak value of each line, a formula corresponding to the sheet edge line is determined by use of the least square method. Then, with the formula, the value of a circumferential position that is the same as the circumferential position of each register mark obtained in Step P208, P209, P210 or P211, i.e., lateral position, is set as the position of the sheet edge. Likewise, the position of the top sheet edge is calculated as below. First, from each of multiple circumferential lines arranged in the lateral direction, differential values are obtained by applying a differential filter to the image data, and the largest value is determined from among the differential values thus obtained. Then, from differential values in the vicinity of the determined largest value, a formula that represents the distribution thereof is determined by use of the least square method, followed by the calculation of a peak value in the determined formula at which the differential value in the formula is zero. The circumferential position of this peak value is then calculated. Next, from the circumferential position of the calculated peak value of each line, a formula corresponding to the sheet edge line is determined by use of the least square method. Then, with the formula, the value of a lateral position that is the same as the lateral position of each register mark obtained in Step P208, P209, P210 or P211, i.e., circumferential position is set as the position of the top sheet edge. Here, the edge extraction method with the differential filter is one generally known, and thus description thereof is omitted here (see Non-patent Literature 1 listed above).

In Step P218, the CPU 10 calculates the lateral distance from the position of the left sheet edge of the front surface to the lateral position of the register mark of each color on the left side of the front surface, and stores the distance in the memory M214. From each of the distance values so calculated, the CPU 10 subtracts a lateral printing position reference distance for the corresponding color on the front surface stored in the memory M220 to thereby calculate the amount of lateral misregister for the color on the front surface, and stores the amount in the memory M224. Note that the amount of lateral misregister can be figured out from the lateral distance after the subtraction, the magnification of the image-capturing camera, and the pitch of the CCD elements of the image-capturing camera. After completing the process in Step P218, the CPU 10 executes Step P219.

In Step P219, the CPU 10 calculates the circumferential distance from the position of the top sheet edge of the front surface on the left side to the circumferential position of the register mark of each color on the left side of the front surface, and stores the distance in the memory M215. From each of the distance values so calculated, the CPU 10 subtracts a circumferential printing position reference distance for the corresponding color on the front surface stored in the memory M221 to thereby calculate the amount of circumferential misregister for the color on the front surface, and stores the amount in the memory M225. Note that the amount of circumferential misregister can be figured out from the circumferential distance after the subtraction, the magnification of the image-capturing camera, and the pitch of the CCD elements of the image-capturing camera. After completing the process in Step P219, the CPU 10 executes Step P220.

In Step P220, the CPU 10 calculates the circumferential distance from the position of the top sheet edge of the front surface on the right side to the circumferential position of the register mark of each color on the right side of the front surface, and stores the distance in the memory M216. From each of the distance values so calculated, the CPU 10 subtracts a circumferential printing position reference distance for the corresponding color on the front surface stored in the memory M215 to thereby calculate the amount of skewing misregister for the color on the front surface, and stores the amount in the memory M226. Note that the amount of skewing misregister can be figured out from the circumferential distance after the subtraction, the magnification of the image-capturing camera, and the pitch of the CCD elements of the image-capturing camera. After completing the process in Step P220, the CPU 10 executes Step P221.

In Step P221, the CPU 10 calculates the lateral distance from the position of the left sheet edge of the back surface to the lateral position of the register mark of each color on the left side of the back surface, and stores the distance in the memory M217. From each of the distance values so calculated, the CPU 10 subtracts a circumferential printing position reference distance for the corresponding color on the back surface stored in the memory M222 to thereby calculate the amount of lateral misregister for the color on the back surface, and stores the amount in the memory M227. After completing the process in Step P221, the CPU 10 executes Step P222.

In Step P222, the CPU 10 calculates the circumferential distance from the position of the top sheet edge of the back surface on the left side to the circumferential position of the register mark of each color on the left side of the back surface, and stores the distance in the memory M218. From each of the distance values so calculated, the CPU 10 subtracts a circumferential printing position reference distance for the corresponding color on the back surface stored in the memory M223 to thereby calculate the amount of circumferential misregister for the color on the back surface, and stores the amount in the memory M228. After completing the process in Step P222, the CPU 10 executes Step P223.

In Step P223, the CPU 10 calculates the circumferential distance from the position of the top sheet edge of the back surface on the right side to the circumferential position of the register mark of each color on the right side of the back surface, and stores the distance in the memory M219. From each of the distance values so calculated, the CPU 10 subtracts a circumferential printing position reference distance for the corresponding color on the back surface stored in the memory M218 to thereby calculate the amount of skewing misregister for the color on the back surface, and stores the amount in the memory M229. After completing the process in Step P223, the CPU 10 executes Step P224.

In Step P224, the CPU 10 calculates the amount of correction for the front-surface circumferential register adjustment unit of each color on the basis of the circumferential misregister for the corresponding color on the front surface, and stores the amount in the memory M230. Note that the amount of correction for the circumferential register adjustment unit can be figured out from the circumferential misregister figured out in Step P219 and the relationship between the amount of drive given to the motor of the circumferential register adjustment unit and the amount of circumferential movement the motor provides. After completing the process in Step P224, the CPU 10 executes Step P225.

In Step P225, the CPU 10 calculates the amount of correction for the front-surface lateral register adjustment unit of each color on the basis of the lateral misregister for the corresponding color on the front surface, and stores the amount in the memory M231. Note that the amount of correction for the lateral register adjustment unit can be figured out from the lateral misregister figured out in Step P218 and the relationship between the amount of drive given to the motor of the lateral register adjustment unit and the amount of lateral movement the motor provides. After completing the process in Step P225, the CPU 10 executes Step P226.

In Step P226, the CPU 10 calculates the amount of correction for the front-surface skewing register adjustment unit of each color on the basis of the skewing misregister for the corresponding color on the front surface, and stores the amount in the memory M232. Note that the amount of correction for the skewing misregister adjustment device can be figured out from the amount of skewing misregister figured out in Step P220, and the distances from the register mark of the corresponding color on the left side and that on the right side to an adjustment reference point of a mechanism of the skewing register adjustment unit, as well as the relationship between the amount of drive given to the motor of skewing register adjustment unit and the degree of skewing angle the motor changes. After completing the process in Step P226, the CPU 10 executes Step P227.

In Step P227, the CPU 10 calculates the amount of correction for the back-surface circumferential register adjustment unit of each color on the basis of the circumferential misregister for the corresponding color on the back surface, and stores the amount in the memory M233. After completing the process in Step P227, the CPU 10 executes Step P228.

In Step P228, the CPU 10 calculates the amount of correction for the back-surface lateral register adjustment unit of each color on the basis of the lateral misregister for the corresponding color on the back surface, and stores the amount in the memory M234. After completing the process in Step P228, the CPU 10 executes Step P229.

In Step P229, the CPU 10 calculates the amount of correction for the back-surface skewing register adjustment unit of each color on the basis of the skewing misregister for the corresponding color on the back surface, and stores the amount in the memory M235. After completing the process in Step P229, the CPU 10 executes Step P230.

In Step P230, the CPU 10 outputs the amounts of correction to the motor drivers of the circumferential, lateral and skewing register adjustment units of each color on the front surface. After completing the process in Step P230, the CPU 10 executes Step P231.

In Step P231, the CPU 10 outputs the amounts of correction to the motor drivers of the circumferential, lateral and skewing register adjustment units of each color on the back surface. By driving the motors of the front- and back-surface circumferential, lateral and skewing register adjustment units of each color in the above-described manner, the positions of patterns to be printed by the respective printing units are adjusted. After completing the process in Step P231, the CPU 10 ends the series of processes and repeats the operation flow until receiving a command to end the control.

The above is the procedure of the processing involving the register apparatus of the printing press and the register method for the printing press according to the second example.

As has been described hereinabove, according to the register apparatus of the printing press and the register method for the printing press according to the present invention, each of the front- and back-surface cameras 31 and 32 or the image-capturing camera 35 captures the register mark 1 and its corresponding edge of the print sheet collectively in one image, and the amount of misregister for each color and between the front and back surfaces is calculated on the basis of the position of the register mark 1 relative to that of the edge of the print sheet. Thus, it is possible to perform registration accurately for each color and between the front and back surfaces.

### INDUSTRIAL APPLICABILITY

The present invention can be used for the registration for each color and between the front and back surfaces in printing presses.

### REFERENCE SIGNS LIST

1 REGISTER MARK

2 BLACK REGISTER MARK

3 CYAN REGISTER MARK

4 MAGENTA REGISTER MARK

5 YELLOW REGISTER MARK

10 CPU

11 ROM

12 RAM

20, 30, 40, 50, 70, 80 INPUT/OUTPUT DEVICE (I/O)

21 IMAGE-CAPTURING TIMING DETECTION COUNTER

22 PRINTING-PRESS ROTATION PHASE DETECTION ROTARY ENCODER

31 FRONT-SURFACE CAMERA

32 BACK-SURFACE CAMERA

33 FRONT-SURFACE ILLUMINATION

34 BACK-SURFACE ILLUMINATION

35 IMAGE-CAPTURING CAMERA

36 COLOR CHECK TABLE

41, 71 INPUT DEVICE

42, 76 DISPLAY

43, 77 CRT

44, 78 RECORDING DEVICE (FD, HDD)

51, 81 FIRST-COLOR REGISTER ADJUSTMENT MECHANISM

52, 82 FRONT-SURFACE FIRST-COLOR REGISTER ADJUSTMENT DEVICE

53, 83 BACK-SURFACE FIRST-COLOR REGISTER ADJUSTMENT DEVICE

54, 84 MOTOR DRIVER OF FRONT-SURFACE FIRST-COLOR CIRCUMFERENTIAL REGISTER ADJUSTMENT UNIT

55, 85 MOTOR OF FRONT-SURFACE FIRST-COLOR CIRCUMFERENTIAL REGISTER ADJUSTMENT UNIT

56, 86 MOTOR DRIVER OF FRONT-SURFACE FIRST-COLOR LATERAL REGISTER ADJUSTMENT UNIT

57, 87 MOTOR OF FRONT-SURFACE FIRST-COLOR LATERAL REGISTER ADJUSTMENT UNIT

58, 90 MOTOR DRIVER OF BACK-SURFACE FIRST-COLOR CIRCUMFERENTIAL REGISTER ADJUSTMENT UNIT

59, 91 MOTOR OF BACK-SURFACE FIRST-COLOR CIRCUMFERENTIAL REGISTER ADJUSTMENT UNIT

60, 92 MOTOR DRIVER OF BACK-SURFACE FIRST-COLOR LATERAL REGISTER ADJUSTMENT UNIT

61, 93 MOTOR OF BACK-SURFACE FIRST-COLOR LATERAL REGISTER ADJUSTMENT UNIT

62, 96 SECOND-COLOR REGISTER ADJUSTMENT MECHANISM

63, 97 THIRD-COLOR REGISTER ADJUSTMENT MECHANISM

64, 98 FOURTH-COLOR REGISTER ADJUSTMENT MECHANISM

72 FRONT-SURFACE LEFT-SIDE IMAGE-CAPTURING BUTTON

73 FRONT-SURFACE RIGHT-SIDE IMAGE-CAPTURING BUTTON

74 BACK-SURFACE LEFT-SIDE IMAGE-CAPTURING BUTTON

75 BACK-SURFACE RIGHT-SIDE IMAGE-CAPTURING BUTTON

88 MOTOR DRIVER OF FRONT-SURFACE FIRST-COLOR SKEWING REGISTER ADJUSTMENT UNIT

89 MOTOR OF FRONT-SURFACE FIRST-COLOR SKEWING REGISTER ADJUSTMENT UNIT

94 MOTOR DRIVER OF BACK-SURFACE FIRST-COLOR SKEWING REGISTER ADJUSTMENT UNIT

95 MOTOR OF BACK-SURFACE FIRST-COLOR SKEWING REGISTER ADJUSTMENT UNIT

1. A register apparatus of a printing press including a printing section to print a pattern, the register apparatus capturing an image of register marks printed in the printing section, and causing a position of the pattern, which is to be printed in the printing section, to be in register on the basis of position of the register mark in the image, the register apparatus comprising:
image-capturing means for capturing an image of an edge of a print sheet together with the register marks, the print sheet already subjected to printing in the printing section; and
adjustment means for adjusting the position of the pattern to be printed in the printing section, on the basis of the position of the register mark in the image and a position of the edge of the print sheet in the image.

2. The register apparatus of the printing press according to claim 1, wherein,
the printing press includes a first printing section to print a pattern of a first color and a second printing section to print a pattern of a second color different from the first color,
the register apparatus of the printing press captures an image of a first register mark and a second register mark printed respectively in the first and second printing sections,
the register apparatus of the printing press causes positions of the patterns, which are to be printed respectively in the first and second printing sections, to be in register on the basis of positions of the first and second register marks in the image,
the image-capturing means captures an image of an edge of a print sheet together with the first and second register marks, the print sheet already subjected to printing in the first and second printing sections, and
the adjustment means adjusts any one of the position of the pattern to be printed in the first printing section and the position of the pattern to be printed in the second printing section, on the basis of the position of the first register mark in the image, the position of the second register mark in the image, and a position of the edge of the print sheet in the image.

3. The register apparatus of the printing press according to claim 1, wherein,
the printing press includes a first printing section to print a pattern on a front surface of a print sheet and a second printing section to print a pattern on a back surface of the print sheet,
the register apparatus of the printing press captures an image of a first register mark and an image of a second register mark printed respectively in the first and second printing sections,
the register apparatus of the printing press causes positions of the patterns, which are to be printed respectively in the first and second printing sections, to be in register on the basis of positions of the first and second register marks in their respective images,
the image-capturing means captures an image of an edge of the print sheet together with the first register mark and also captures an image of the edge of the print sheet together with the second register mark, the print sheet already subjected to printing in the first and second printing sections, and
the adjustment means adjusts any one of the position of the pattern to be printed in the first printing section and the position of the pattern to be printed in the second printing section, on the basis of the position of the first register mark in the image, a position of the edge of the print sheet in the image captured together with the first register mark, the position of the second register mark in the image, and a position of the edge of the print sheet in the image captured together with the second register mark.

4. The register apparatus of the printing press according to claim 1, wherein the registration is position alignment in a lateral direction.

5. The register apparatus of the printing press according to claim 1, wherein the registration is position alignment in a circumferential direction.

6. The register apparatus of the printing press according to claim 1, wherein the registration is position alignment in a skewing direction.

7. A register method for a printing press including a printing section to print a pattern and having a register apparatus that captures an image of a register mark printed in the printing section and causes a position of the pattern, which are to be printed in the printing section, to be in register on the basis of a position of the register mark in the image, the register method comprising:
capturing an image of an edge of a print sheet together with the register mark, the print sheet already subjected to printing in the printing section; and
adjusting the position of the pattern to be printed in the printing section, on the basis of the position of the register mark in the image and a position of the edge of the print sheet in the image.

8. The register method for the printing press according to claim 7, wherein,
the printing press includes a first printing section to print a pattern of a first color and a second printing section to print a pattern of a second color different from the first color,
the register apparatus of the printing press captures an image of a first register mark and a second register mark printed respectively in the first and second printing sections,
the register apparatus of the printing press causes positions of the patterns, which are to be printed respectively in the first and second printing sections, to be in register on the basis of positions the first and second register marks in the image,
capturing an image of an edge of a print sheet together with the first and second register marks, the print sheet already subjected to printing in the first and second printing sections, and
adjusting any one of the position of the pattern to be printed in the first printing section and the position of the pattern to be printed in the second printing section, on the base of the position of the first register mark in the image, the position of the second register mark in the image, and a position of the edge of the print sheet in the image.

9. The register method for the printing press according to claim 7, wherein,
the printing press includes a first printing section to print a pattern on a front surface of a print sheet and a second printing section to print a pattern on a back surface of the print sheet, or a first printing section to print a pattern on a back surface of a print sheet and a second printing section to print a pattern on a front surface of the print sheet,
the register apparatus of the printing press captures an image of a first register mark and an image of a second register mark printed respectively in the first and second printing sections,
the register apparatus of the printing press causes positions of the patterns, which are to be printed respectively in the first and second printing sections, to be in register on the basis of positions of the first and second register marks in their respective images,
capturing an image of an edge of the print sheet together with the first register mark, the print sheet already subjected to printing in the first and second printing sections, and
capturing an image of the edge of the print sheet together with the second register mark, the print sheet already subjected to printing in the first and second printing sections, and
adjusting any one of the position of the pattern to be printed in the first printing section and the position of the pattern to be printed in the second printing section, on the base of the position of the first register mark in the image, a position of the edge of the print sheet in the image captured together with the first register mark, the position of the second register mark in the image, and a position of the edge of the print sheet in the image captured together with the second register mark.

10. The register method for the printing press according to claim 7, wherein the registration is position alignment in a lateral direction.

11. The register method for the printing press according to claim 7, wherein the registration is position alignment in a circumferential direction.

12. The register method for the printing press according to claim 7, wherein the registration is position alignment in a skewing direction.
